(19) United States
(12) Patent Application Publication
(10) Pub. No.: US 2025/0166374 A1
(43) Pub. Date: May 22, 2025

(54) EDGE DEVICE AND METHOD OF EXTRACTING CHARACTERISTICS OF SMART FARM CROPS

(71) Applicant: ELECTRONICS AND TELECOMMUNICATIONS RESEARCH INSTITUTE, Daejeon (KR)

(72) Inventors: Junyong Park, Daejeon (KR); Yong Hyuk Moon, Daejeon (KR)

(21) Appl. No.: 18/764,552

(22) Filed: Jul. 5, 2024

(30) Foreign Application Priority Data
Nov. 20, 2023 (KR) 10-2023-0161117

(51) Int. Cl. G06V 20/10; G06T 7/50; G06T 17/00; G06V 10/764

(52) U.S. Cl. CPC G06V 20/188; G06T 7/50; G06T 17/00; G06V 10/764; G06T 2207/10028; G06T 2207/20084

(57) ABSTRACT

A method of extracting characteristics of smart farm corps includes a step of extracting depth information about a crop object by using an extraction module, based on a depth image and an RGB image, and extracting object information about the crop object, based on the RGB image, a step of extracting space characteristic information representing a shape, a size, and a direction of the crop object in a 3D space by using a space characteristic extraction module, based on the depth information and the object information, a step of reconstructing a 3D model of the crop object in the 3D space by using a 3D model reconstruction module, based on the space characteristic information, and a step of inferring volume information and pose information about the crop object by using an inference module, based on the reconstructed 3D model.

### CROSS-REFERENCE TO RELATED APPLICATION(S)

This application claims the benefit of the Korean Patent Application No. 10-2023-0161117 filed on Nov. 20, 2023, which is hereby incorporated by reference as if fully set forth herein.

### BACKGROUND

### 1. Field of the Invention

The present invention relates to technology for extracting characteristics of crops in a smart farm environment, and more particularly, to technology for extracting characteristics of crops by using an edge device equipped in an autonomous mobile robot.

### 2. Description of Related Art

Smart farm technology has advanced to a significant means for enhancing the modernization and productivity of agriculture. Particularly, an operation of accurately evaluating characteristics such as growth states of crops is a significant portion of production optimization, quality management, and automatic harvest technology.

Conventional smart farm technology evaluates characteristics of crops by using a two-dimensional (2D) image of the crops. Due to a limitation of such a 2D image, it is difficult to accurately evaluate a three-dimensional (3D) shape of crops and the other significant characteristics.

Moreover, in the conventional smart farm technology, an autonomous mobile robot is used for crop harvest, and a central server and a central computing resource are needed for controlling the autonomous mobile robot. In a case where an autonomous mobile robot harvests crops such as fruits, the central server should accurately infer a six-dimensional (6D) pose of the autonomous mobile robot so as to precisely control the autonomous mobile robot. Such an inference operation concentrates on the central server, and due to this, a real-time processing speed and inference accuracy are limited. Due to such a limitation, a case frequently occurs where the autonomous mobile robot abnormally picks up fruits to cause the damage of fruits.

Moreover, in a smart farm system of the related art, because a central server processes massive data, it is difficult to determine the maturity of fruits in real time and immediately harvest fruits, due to the delay of data and a limitation of a processing speed.

### SUMMARY

An aspect of the present invention is directed to providing an edge device and a method thereof, which may accurately reconstruct a 3D model of crops so as to solve a problem of a conventional 2D image analysis method difficult to recognize an accurate volume and a 3D shape of crops, based on an RGBD image.

Another aspect of the present invention is directed to providing an edge device and a method thereof, which may accurately infer a 6D pose representing direction information and positions of crops so as to accurately and quickly harvest fruits without being damaged.

Another aspect of the present invention is directed to providing an edge device and a method thereof, which may overall analyze sizes, colors, 3D shapes, and position information of crops to accurately determine the maturity of the crops.

To achieve these and other advantages and in accordance with the purpose of the invention, as embodied and broadly described herein, there is provided a method of extracting characteristics of smart farm corps in an edge device equipped in a robot, the method including: a step of extracting depth information about a crop object by using an extraction module, based on a depth image and an RGB image, and extracting object information about the crop object, based on the RGB image; a step of extracting space characteristic information representing a shape, a size, and a direction of the crop object in a three-dimensional (3D) space by using a space characteristic extraction module, based on the depth information and the object information; a step of reconstructing a 3D model of the crop object in the 3D space by using a 3D model reconstruction module, based on the space characteristic information; and a step of inferring volume information and pose information about the crop object by using an inference module, based on the reconstructed 3D model.

In another aspect of the present invention, there is provided a control method of a robot including: a step of extracting depth information about a crop object by using an extraction module, based on a depth image and an RGB image, and extracting object information about the crop object, based on the RGB image; a step of extracting space characteristic information representing a shape, a size, and a direction of the crop object in a three-dimensional (3D) space by using a space characteristic extraction module, based on the depth information and the object information; a step of reconstructing a 3D model of the crop object configured with a point cloud by using a 3D model reconstruction module, based on the space characteristic information; a step of inferring volume information and pose information about the crop object by using an inference module, based on the reconstructed 3D model; a step of generating an operation control instruction by using an operation control module, based on the volume information and the pose information; and a step of controlling an operation of a robotic arm according to the operation control instruction by using a robot actuator.

In another aspect of the present invention, there is provided an edge device equipped in a robot, the edge device including: an extraction module configured to extract depth information about a crop object, based on a depth image and an RGB image, and extract object information about the crop object, based on the RGB image; a space characteristic extraction module configured to extract space characteristic information representing a shape, a size, and a direction of the crop object in a three-dimensional (3D) space, based on the depth information and the object information; a 3D model reconstruction module configured to reconstruct a 3D model of the crop object configured with a point cloud, based on the space characteristic information; and an inference module configured to infer volume information and pose information about the crop object, based on the reconstructed 3D model.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a configuration diagram of an autonomous mobile robot according to an embodiment of the present invention.

FIG. 2 is a detailed configuration diagram of an inference module of FIG. 1.

FIG. 3 is a diagram visually illustrating a processing process by the inference module of FIG. 2.

FIG. 4 is a flowchart for describing a method of controlling a robot by using an edge device included in the robot according to an embodiment of the present invention.

FIG. 5 is a diagram for describing a learning system of a robotic arm based on the inference module of FIG. 1.

FIG. 6 is a diagram for describing a process of generating a data set for teaching the inference module based on an artificial neural network of FIG. 1.

### DETAILED DESCRIPTION OF THE INVENTION

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

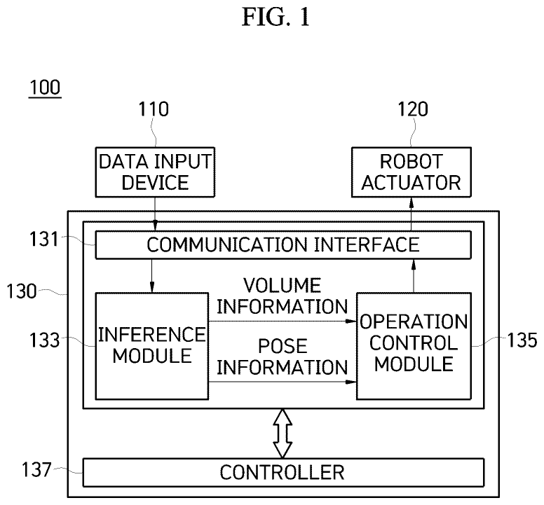

FIG. 1 is a configuration diagram of an autonomous mobile robot 100 according to an embodiment of the present invention.

Referring to FIG. 1, the autonomous mobile robot 100 (hereinafter referred to as a ‘robot’) according to an embodiment of the present invention may perform an operation such as crop harvest in a smart farm environment. To this end, the robot 100 may include a data input device 110, a robot actuator 120, and an edge device 130.

The data input device 110 may be a device which obtains a red, green, blue, and depth (RGBD) image including a red, green, and blue (RGB) image and a depth image of at least one crops. To this end, the data input device 110 may include an RGB camera and a depth camera. The RGB camera may photograph at least one crops in a smart farm environment to capture an RGB image including color information about the at least one crops. The depth camera may photograph the at least one crops in the smart farm environment to capture a depth image including depth information about the at least one crops. Here, the depth information may include distance information up to target crops from the depth camera. The RGB camera and the depth camera may be integrated as one camera. The RGBD image obtained by the data input device 110 may be input to the edge device 130.

The robot actuator 120 may be a mechanical device which controls an operation of the robot 100 according to an operation instruction input from the edge device 130. Here, the operation of the robot 100 may include operations associated with legs, arms, wheels, robotic arms, joints, and a moving speed of the robot 100. To control such operations, the robot actuator 120 may include an electric actuator, a hydraulic actuator, and a pneumatic actuator. The present invention may be characterized in mechanical element of the robot actuator 120, and thus, its description may be replaced with known technology.

The edge device 130 may analyze an RGBD image input from the data input device 110 to infer volume information (size information) about at least one crop objects included in the RGBD image. Also, the edge device 130 may analyze the RGBD image input from the data input device 110 to infer pose information about the at least one crop objects included in the RGBD image. Here, the pose information may include position information and direction information about the crop object in a 3D space. Here, the position information may include X-axis coordinates, Y-axis coordinates, and Z-axis coordinates of the crop object, and the direction information may include an X-axis rotation angle (Roll), a Y-axis rotation angle (Pitch), and a Z-axis rotation angle (Yaw).

The edge device 130 may include a communication interface 131, an inference module 133, and an operation control module 135, so as to infer volume information and pose information about a crop object on the basis of an RGBD image. Also, the edge device 130 may further include a controller 137 for controlling and/or executing of operations of the elements 131, 133, and 135.

The communication interface 131 may be a device which performs interfacing for data or information exchange between the elements 110 and 120 and the edge device 130. The communication interface 131 may include, for example, RS-232, RS-485, USB, UART, SPI, I2C, parallel ports, IDE, and SCSI.

The inference module 133 may be configured with a software module, a hardware module, or a combination thereof, which is controlled by the controller 137. The inference module 133 may analyze the RGBD image input from the data input device 110 through the communication interface 131 to reconstruct a 3D model of at least one crop objects included in the RGBD image and may precisely infer volume information (or size information) about the crop object, based on the reconstructed 3D model of the crop object. Also, the inference module 133 may analyze the RGBD image to infer pose information about the at least one crop objects included in the RGBD image in a 3D space, so as to precisely control the operation of the robot 100. The inference module 133 will be described below in detail.

The operation control module 135 may be configured with a software module, a hardware module, or a combination thereof, which is controlled by the controller 137. The operation control module 135 may generate an operation instruction for controlling the operation (for example, an operation of the robotic arm) of the robot 100, based on an inference result (for example, semantic information, volume information, and pose information) of the inference module 122, and may transfer the operation instruction to the robot actuator 120 through the communication interface 131. Therefore, the robot actuator 120 may control the operations associated with the legs, arms, wheels, robotic arms, joints, and moving speed of the robot 100, based on the operation instruction.

Moreover, as described above, the controller 137 may be an element which controls and/or executes the operations of the elements 131, 133, and 135 and may be a logic chip configured to include at least one processor and at least one memory. The logic chip may be, for example, a micro-controller unit (MCU). Also, the controller 137 may support an operation performed on each of the inference module 133 and the operation control module 135. For example, the controller 137 may process an intermediate data result obtained through processing by each of the inference module 133 and the operation control module 135 to provide to the inference module 133 and the operation control module 135. Also, the controller 137 or a processor included in the controller 137 may control and execute operations of the elements 210, 220, 230, 240, 250, 260, and 270 included in the inference module 133, which will be described below.

In FIG. 1, the inference module 133, the operation control module 135, and the controller 137 are illustrated as a split type, but are not limited thereto and may be integrated as one element. For example, the inference module 133 and the operation control module 135 may be embedded in the controller 137.

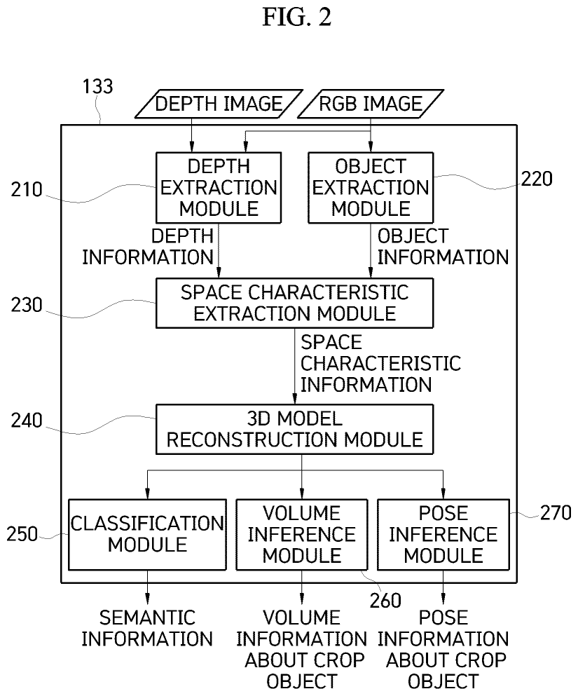

FIG. 2 is a detailed configuration diagram of the inference module 133 of FIG. 1.

Referring to FIG. 2, the inference module 133 may include a depth-based characteristic extraction module 210, an object extraction module 220, a space characteristic extraction module 230, a 3D model reconstruction module 240, a classification module 250, a volume inference module 260, and a pose inference module 270.

### Depth Extraction Module 210

The depth extraction module 210 may simultaneously analyze a depth image and an RGB image to extract depth information about the same at least one crop object included in the depth image and the RGB image. The depth information may include a shape, a size, and a position of a crop object included in each of the depth image and the RGB image.

To extract depth-based characteristic information, the depth-based characteristic extraction module 210 may be implemented with an artificial neural network which is pre-learned to extract depth information from the depth image and the RGB image.

The artificial neural network may use, for example, a convolutional neural network (CNN) which is useful for extracting a characteristic from image, video, or multi-dimensional data. For example, CNN may be configured to perform a concatenation process of concatenating the depth image with the RGB image, a convolution operation for extracting depth information from an image generated, a batch normalization process, and a non-linear activation process. The convolution operation, the batch normalization process, and the non-linear activation process may be the terms which are widely used in the field of convolution neural network, and their descriptions may be replaced with known technology.

### Object Extraction Module 220

The object extraction module 220 may analyze the RGB image to extract object information for distinguishing at least one crop object or a plurality of crop objects included in the RGB image. Here, the object information may be information about where a boundary of each crop object is represented by pixel units in the RGB image.

The object extraction module 220 may be implemented with an artificial neural network which is pre-learned to extract the object information from the RGB image. The artificial neural network may be configured to include, for example, Efficientnet, Backbone such as Resnet, and feature pyramid network (FPN).

Backbone may be a core structure of a neural network which extracts significant characteristics from the RGB image and may be configured with CNN such as ResNet, VGG, or EfficientNet. Backbone may detect objects having various sizes and complexity in an input image. FPN may have a function of simultaneously detecting and segmenting the objects having various sizes detected by Backbone. When crop objects having various sizes are individually detected by Backbone and FPN, a process of extracting a boundary of each crop object by pixel units by using an object instance segmentation process may be performed. The extracted boundary of each crop object may be output as instance mask information. The instance mask information may be used as the same term as boundary information about the crop object described above.

### Space Characteristic Extraction Module 230

The space characteristic extraction module 230 may analyze the depth information from the depth extraction module 210 and the object information from the object extraction module 220 to extract space characteristic information about at least one crop object in a 3D space. Here, the space characteristic information may include a shape, a size, a direction, and a relative position of the crop object.

To extract the space characteristic information, the space characteristic extraction module 230 may be implemented with a pre-learned artificial neural network. The artificial neural network may use, for example, CNN which performs a convolution operation on depth information and object information.

### 3D Model Reconstruction Module 240

The 3D model reconstruction module 240 may reconstruct (recover) a 3D model of a crop object in the 3D space, based on the space characteristic information from the space characteristic extraction module 230. Here, the reconstructed 3D model may include point cloud data. The point cloud data may be expressed as a set of points which are in the 3D space. Each point may include attributes such as coordinate information, a color, and a pixel value in the 3D space. The point cloud data may be managed as a tensor type, and thus, the 3D model of the crop object may be precisely expressed and processed in a digital environment.

The 3D model reconstruction module 240 may be implemented with an artificial neural network for reconstructing the 3D model of the crop object. The artificial neural network may include a rescaling block which adjusts a size of the space characteristic information, a convolution block which performs a convolution operation on the size-adjusted space characteristic information, and an output block which outputs space characteristic information, obtained through the convolution operation, as a point cloud tensor type. The artificial neural network may use, for example, CNN. CNN may be learned to reconstruct the 3D model of the crop object, based on the space characteristic information.

### Classification Module 250

The classification module 250 may segment the 3D model, reconstructed by the 3D model reconstruction module 240, into detailed models and may classify a category or a class in which each of the detailed models is. For example, the classification module 250 may classify crop objects, reconstructed to the 3D model, into a fruit class, a leaf class, and a stem class.

The classification module 250 may cluster points of the point cloud into a plurality of clusters through segmentation and classification processes to segment the reconstructed 3D model into detailed models, and then, may allocate a class to each cluster to classify the detailed models, based on the class, and may infer a semantic image for distinguishing the detailed models classified based on the class.

Based on a shape of a detailed model distinguished through the semantic image, the classification module 250 may determine a portion which is to be cut, or a portion which corresponds to leaf, or whether a crop object is damaged by blight, in a process of harvesting the crop object by using a robot.

The classification module 250 may be implemented with an artificial neural network which is pre-learned to segment and classify a 3D model, based on a semantic segmentation technique. For example, the artificial neural network may cluster the points of the point cloud, configuring the 3D model, to several clusters. In this case, each of the clusters may be configured with points having the same attribute such as the same color or the same pixel value. Subsequently, the artificial neural network may allocate a category or a class such as fruit, leaf, or stem to each cluster, and thus, a semantic image for distinguishing the detailed models classified based on the class may be inferred.

### Volume Inference Module 250

The volume inference module 250 may infer volume (size) information about a crop object corresponding to the reconstructed 3D model, based on the 3D model reconstructed by the 3D model reconstruction module 240.

To infer the volume information about the crop object, the volume inference module 250 may calculate a convex hull corresponding to the point cloud configuring the reconstructed 3D model. Here, the convex hull may denote a convex polygon which surrounds points configuring an outer boundary of the reconstructed 3D model. The convex hull may be calculated by various methods, and for example, Graham's scan algorithm, Jarvis march algorithm, or an artificial neural network pre-learned to calculate the convex hull may be used. Subsequently, the volume inference module 250 may infer volume information about a crop object representing the reconstructed 3D model, based on the calculated convex hull. The volume information may be calculated by a geometrical method which measures or approximates an internal space of the convex hull.

### Pose Inference Module 270

The pose inference module 270 may infer pose information about a crop object corresponding to the reconstructed 3D model, based on the 3D model reconstructed by the 3D model reconstruction module 240.

The pose information may include position information and direction information about the crop object corresponding to the reconstructed 3D model. The position information may include X, Y, and Z coordinates of the crop object where a camera or a robot is a reference point (an original point) in the 3D space. The direction information may be information representing a direction in which the crop object (the reconstructed 3D model) is inclined with respect to a camera or a robot corresponding to a reference point (an original point) in the 3D space and may include an X-axis rotation angle (Roll), a Y-axis rotation angle (Pitch), and a Z-axis rotation angle (Yaw).

The pose inference module 270 may be configured with an artificial neural network which is pre-learned to infer the pose information about the crop object by using a point cloud configuring the reconstructed 3D model. The artificial neural network may be configured as, for example, CNN, recurrent neural network (RNN), or a combination thereof.

The artificial neural network learned to infer the pose information may be configured to include a down-sampling block which down-samples a size (density) of the point cloud configuring the reconstructed 3D model, a fully connected block which is configured as a fully connected layer for extracting characteristics (a position, a color, and a pixel value) of each point included in a down-sampled point cloud, and a pose prediction block which predicts the pose information about the crop object, based on the characteristics of each point processed by the fully connected block.

Moreover, some of the elements 210 to 270 illustrated in FIG. 2 may be integrated as one element. For example, the depth extraction module 210 and the object extraction module 220 may be integrated as one extraction module. Therefore, an artificial neural network included in the depth extraction module 210 and an artificial neural network included in the object extraction module 220 may be integrated as one artificial neural network. Also, the space characteristic extraction module 230 and the 3D model reconstruction module 240 may also be integrated as one extraction module, and for example, the space characteristic extraction module 230 may be embedded in the 3D model reconstruction module 240. Accordingly, an artificial neural network included in the space characteristic extraction module 230 and an artificial neural network included in the 3D model reconstruction module 240 may be integrated as one artificial neural network. Also, the classification module 250, the volume inference module 260, and the pose inference module 270 may be integrated as one inference module. Therefore, artificial neural networks respectively included in the classification module 250, the volume inference module 260, and the pose inference module 270 may be integrated as one artificial neural network.

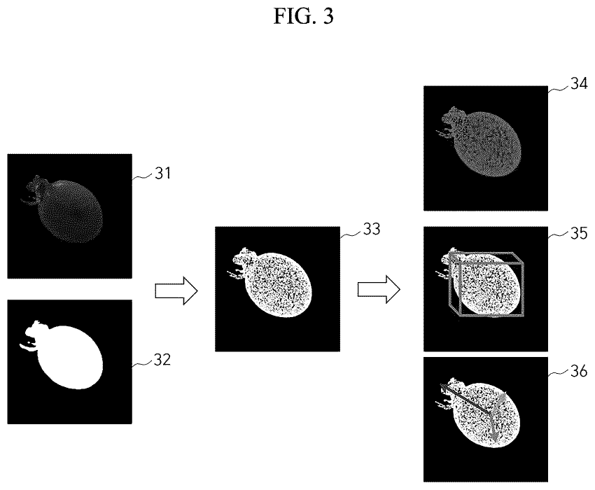

FIG. 3 is a diagram visually illustrating a processing process by the inference module 133 of FIG. 2.

Referring to FIG. 3, reference numeral 31 may refer to an RGB image input to the inference module 133, and reference numeral 32 may refer to a depth image input to the inference module 133. Reference numeral 33 may refer to a 3D model which is configured as a point cloud reconstructed by the 3D model reconstruction module (240 of FIG. 2), based on the RGB image 31 and the depth image 32. Reference numeral 34 may refer to semantic information or a semantic image which is generated by the classification module (250 of FIG. 2), based on the 3D model 33. Reference numeral 35 may visually express a volume inference process based on a block hull in the volume inference module 260. Also, reference numeral 35 may visually express a pose inference process in the pose inference module 270.

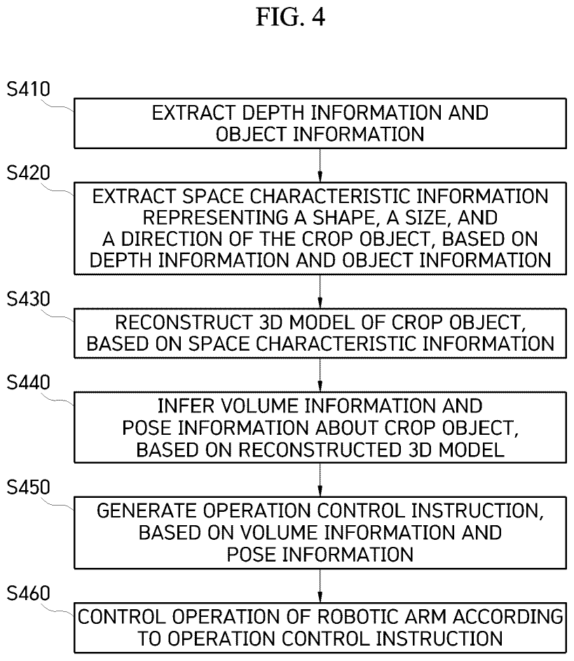

FIG. 4 is a flowchart for describing a method of controlling a robot by using an edge device included in the robot according to an embodiment of the present invention.

Referring to FIG. 4, first, in step S410, a process of extracting depth information about a crop object, based on a depth image and an RGB image, and extracting object information about the crop object, based on the RGB image, may be performed in the extraction module (210 and 220 of FIG. 2).

Subsequently, in step S420, a process of extracting space characteristic information representing a shape, a size, and a direction of the crop object in a 3D space, based on the depth information and the object information, may be performed in the space characteristic extraction module (230 of FIG. 2).

Subsequently, in step S430, a process of reconstructing a 3D model of the crop object in the 3D space, based on the space characteristic information, may be performed in the 3D model reconstruction module (240 of FIG. 2).

Subsequently, in step S440, a process of inferring volume information and pose information about the crop object, based on the reconstructed 3D model, may be performed in the inference module (260 and 270 of FIG. 2).

Subsequently, in step S450, a process of generating an operation control instruction, based on the volume information and the pose information, may be performed in the operation control module (135 of FIG. 1).

Subsequently, in step S460, a process of controlling an operation of a robotic arm according to the operation control instruction may be performed in the robot actuator (120 of FIG. 1).

In an embodiment, by using an artificial neural network, step S430 may include a process of reconstructing the crop object to the 3D model where the crop object is configured with a point cloud, based on the space characteristic information.

In an embodiment, step S440 may include a process of inferring the volume information about the crop object, based on the point cloud configuring the reconstructed 3D model.

In an embodiment, step S440 may include a process of calculating a convex hull corresponding to the point cloud configuring the reconstructed 3D model and a process of inferring the volume information about the crop object, based on the calculated convex hull.

In an embodiment, step S440 may include a process of extracting characteristics of each point included in the point cloud configuring the reconstructed 3D model and a process of predicting the pose information about the crop object, based on the extracted characteristics of each point.

In an embodiment, the pose information may include position information and direction information about the crop object corresponding to the reconstructed 3D model. Here, the position information may include X, Y, and Z coordinates of the reconstructed 3D model (the crop object) where the robot is a reference point in the 3D space. The direction information may be information representing a direction in which the reconstructed 3D model (the crop object) is inclined with respect to the robot corresponding to a reference point in the 3D space and may include an X-axis rotation angle (Roll), a Y-axis rotation angle (Pitch), and a Z-axis rotation angle (Yaw).

In an embodiment, step S440 may further include a process of inferring a semantic image of the crop object, based on the point cloud configuring the reconstructed 3D model.

In an embodiment, step S440 may include a process of clustering points of the point cloud into a plurality of clusters and segmenting the reconstructed 3D model into detailed models, a process of allocating a class to each cluster to classify the detailed models, based on the class, and a process of inferring a semantic image for distinguishing the detailed models classified based on the class.

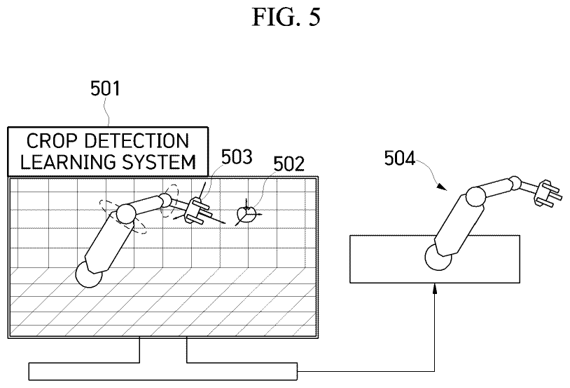

FIG. 5 is a diagram for describing a learning system of a robotic arm based on the inference module of FIG. 1.

Referring to FIG. 5, due to the complexity and uncertainty of a real environment, it may be difficult to directly teach a robotic arm. Therefore, first, learning of an inference module for controlling the robotic arm in a simulation environment may be performed.

Learning in a virtual environment may assign, to the robotic arm, capability for accurately detecting a crop object and performing a relevant operation under various scenarios and conditions. Knowledge based on such learning may be actually transferred to the robotic arm and may be applied to crops of real world.

A crop detection learning system 501 may be a computing device which supports learning of an inference module based on an artificial neural network for crop detection and various operations and includes at least one processor (a central processing unit (CPU) and a graphics processing unit (GPU)) and a memory. A simulator executed by the crop detection learning system 501 may perform learning in real time by using virtual data, and a learned model may be actually applied to the robotic arm.

A virtual crop object 502 generated by the simulator may have various shapes, sizes, and colors and may be disposed in a simulation space generated by the simulator. The robotic arm may perform a detection and harvest exercise on the virtual crop object 502.

A virtual robotic arm 503 generated by the simulator may operate in the simulation space and may act identically to a motion of a real robotic arm 504. The virtual robotic arm 503 may repeatedly learn an operation of accurately detecting the virtual crop object 502 by using the inference module 133 based on the artificial neural network, moving to a corresponding position, and harvesting crops.

A crop detection algorithm learned in the simulator may be loaded into the robotic arm 504 which is in a real space. Through such a knowledge transfer process, knowledge and experience learned in virtual reality may be applied to the real robotic arm 504, and thus, an effective operation may be possible in a real environment. Such a knowledge transfer process may be a kind of method which is frequently used in deep learning and robotics field, and effective learning and execution may be simultaneously performed through a process of transferring knowledge, obtained in a simulation environment, to the real environment.

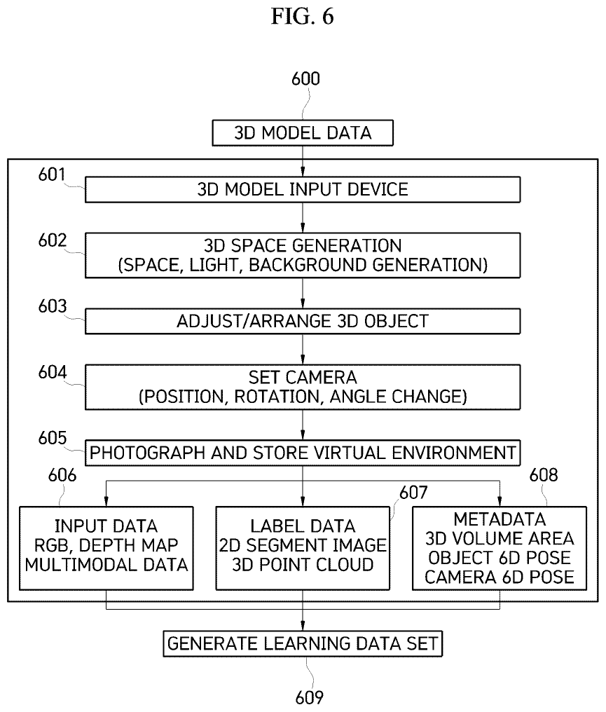

FIG. 6 is a diagram for describing a process of generating a data set for teaching the inference module based on an artificial neural network of FIG. 1.

Referring to FIG. 6, a learning data set may be needed for teaching an inference module based on an artificial neural network, and the learning data set may be generated by a dedicated system for precisely representing a structure and an environment of a complicated crop. The dedicated system may digitalize information obtained in a real environment to generate a learning data set and may be a computing device which includes a processor and a memory.

First, 3D model data 600 may be input to a 3D model input device 601 of the dedicated system. The 3D model data 600 may be a 3D virtual model where crops of real world are converted into a digital form. The 3D model input device 601 may be a device for inputting 3D scan data of real crops to the dedicated system.

The dedicated system may generate a 3D virtual space in step 602. A process of generating the 3D virtual space may set a space, illumination, and background for simulation in a virtual environment.

Subsequently, in step 603, a process of adjusting or arranging a position or a direction of a 3D model in a virtual space may be performed.

Subsequently, in step 604, a process of setting a camera may be performed. Such a process may be a process of setting parameters such as a position, a direction, a rotation, a slope, and a distance of the camera for simulation at various perspectives and viewpoints.

Subsequently, in step 605, a process of photographing a virtual environment and storing a photograph result as data at a viewpoint of the camera on which the setting of parameters is completed.

Subsequently, in step 606, a process of collecting data obtained in an RGB image, a depth map (a depth image), and various modalities may be performed.—input data—

Subsequently, in step 607, a process of collecting a 2D segmentation image which is to be used in learning of the object extraction module (220 of FIG. 2) and a 3D point cloud which is to be used in learning of the 3D model reconstruction module (240 of FIG. 2) and the classification module (250 of FIG. 2).—label data—

Subsequently, in step 608, a process of collecting a 3D volume area which is to be used in learning of the volume inference module (260 of FIG. 2), a 6D (6 degree of freedom) position and direction of an object which is to be used in learning of the pose inference module (270 of FIG. 2), and a 6D position and direction (used in updating of position and direction information about an object based on a viewpoint change of a camera) of a camera may be performed.—metadata—

Subsequently, in step 609, as the collection of the input data, the label data, and the metadata is completed, a process of reproducing a complicated condition and situation in the real environment to complete generating of precise and various learning data sets needed for learning of an artificial neural network of the robotic arm may be performed.

According to the embodiments of the present invention, the edge device equipped in an autonomous mobile robot may accurately reconstruct a 3D model of crops, based on an RGBD image, thereby overcoming a limitation of a conventional 2D image analysis method difficult to recognize an accurate volume and a 3D shape of crops.

Moreover, the edge device equipped in the autonomous mobile robot may accurately infer a 6D pose of the autonomous mobile robot based on position information and direction information about crops, and thus, the autonomous mobile robot may accurately and quickly harvest fruits without being damaged.

Moreover, the edge device equipped in the autonomous mobile robot may overall analyze sizes, colors, 3D shapes, and position information of crops to accurately determine the maturity of the crops.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of extracting characteristics of smart farm corps in an edge device equipped in a robot, the method comprising:
a step of extracting depth information about a crop object by using an extraction module, based on a depth image and an RGB image, and extracting object information about the crop object, based on the RGB image;
a step of extracting space characteristic information representing a shape, a size, and a direction of the crop object in a three-dimensional (3D) space by using a space characteristic extraction module, based on the depth information and the object information;
a step of reconstructing a 3D model of the crop object in the 3D space by using a 3D model reconstruction module, based on the space characteristic information; and
a step of inferring volume information and pose information about the crop object by using an inference module, based on the reconstructed 3D model.

2. The method of claim 1, wherein the step of reconstructing the 3D model comprises a step of reconstructing, by using an artificial neural network, the 3D model where the crop object is configured with a point cloud, based on the space characteristic information.

3. The method of claim 1, wherein the step of inferring the volume information and the pose information comprises a step of inferring the volume information about the crop object, based on the point cloud configuring the reconstructed 3D model.

4. The method of claim 1, wherein the step of inferring the volume information and the pose information comprises:
a step of calculating a convex hull corresponding to the point cloud configuring the reconstructed 3D model; and
a step of inferring the volume information about the crop object, based on the calculated convex hull.

5. The method of claim 1, wherein the step of inferring the volume information and the pose information comprises:
a step of extracting characteristics of each point included in the point cloud configuring the reconstructed 3D model; and
a step of predicting the pose information about the crop object, based on the extracted characteristics of each point.

6. The method of claim 5, wherein the pose information comprises position information including X, Y, and Z coordinates of the crop object with respect to the robot corresponding to a reference point in the 3D space and direction information including an X-axis rotation angle (Roll), a Y-axis rotation angle (Pitch), and a Z-axis rotation angle (Yaw) each representing a direction in which the reconstructed 3D model is inclined with respect to the robot corresponding to the reference point in the 3D space.

7. The method of claim 1, wherein the step of inferring the volume information and the pose information further comprises a step of inferring a semantic image of the crop object, based on the point cloud configuring the reconstructed 3D model.

8. The method of claim 7, wherein the step of inferring the volume information and the pose information comprises:
a step of clustering points of the point cloud into a plurality of clusters and segmenting the reconstructed 3D model into detailed models;
a step of allocating a class to each cluster to classify the detailed models, based on the class; and
a step of inferring a semantic image including the detailed models classified based on the class.

9. A control method of a robot, the control method comprising:
a step of extracting depth information about a crop object by using an extraction module, based on a depth image and an RGB image, and extracting object information about the crop object, based on the RGB image;
a step of extracting space characteristic information representing a shape, a size, and a direction of the crop object in a three-dimensional (3D) space by using a space characteristic extraction module, based on the depth information and the object information;
a step of reconstructing a 3D model of the crop object configured with a point cloud by using a 3D model reconstruction module, based on the space characteristic information;
a step of inferring volume information and pose information about the crop object by using an inference module, based on the reconstructed 3D model;
a step of generating an operation control instruction by using an operation control module, based on the volume information and the pose information; and
a step of controlling an operation of a robotic arm according to the operation control instruction by using a robot actuator.

10. The control method of claim 9, wherein the step of inferring the volume information and the pose information comprises:
a step of calculating a convex hull corresponding to the point cloud configuring the reconstructed 3D model; and
a step of inferring the volume information about the crop object, based on the calculated convex hull.

11. The control method of claim 9, wherein the step of inferring the volume information and the pose information comprises:
a step of extracting characteristics of each point included in the point cloud configuring the reconstructed 3D model; and
a step of predicting the pose information about the crop object, based on the extracted characteristics of each point.

12. The control method of claim 9, wherein the operation of the robotic arm is an operation of harvesting the crop object.

13. An edge device equipped in a robot, the edge device comprising:
an extraction module configured to extract depth information about a crop object, based on a depth image and an RGB image, and extract object information about the crop object, based on the RGB image;
a space characteristic extraction module configured to extract space characteristic information representing a shape, a size, and a direction of the crop object in a three-dimensional (3D) space, based on the depth information and the object information;
a 3D model reconstruction module configured to reconstruct a 3D model of the crop object configured with a point cloud, based on the space characteristic information; and
an inference module configured to infer volume information and pose information about the crop object, based on the reconstructed 3D model.

14. The edge device of claim 13, wherein the inference module calculates a convex hull corresponding to the point cloud configuring the reconstructed 3D model and infers the volume information about the crop object, based on the calculated convex hull.

15. The edge device of claim 13, wherein the inference module extracts characteristics of each point included in the point cloud configuring the reconstructed 3D model and predicts the pose information about the crop object, based on the extracted characteristics of each point.

16. The edge device of claim 13, wherein the inference module further infers a semantic image of the crop object, based on the point cloud configuring the reconstructed 3D model.

17. The edge device of claim 16, wherein the inference module clusters points of the point cloud into a plurality of clusters and segmenting the reconstructed 3D model into detailed models, allocates a class to each cluster to classify the detailed models, based on the class, and infers a semantic image including the detailed models classified based on the class.
